(19) United States
(12) Patent Application Publication
(10) Pub. No.: US 2026/0342275 A1
(43) Pub. Date: Oct. 29, 2026

(54) ANTI-SOILING MODULE

(71) Applicant: Maxeon Solar Pte. Ltd., Singapore (SG)

(72) Inventors: SIMON SUN, Taizhou (CN); KEVIN CHEN, Wuxi (CN); EDWIN ALEXANDER PERAZA HERNANDEZ, San Jose, CA (US); NICHOLAS BERRY, Beaverton, OR (US); YAFU LIN, Pleasanton, CA (US)

(21) Appl. No.: 19/187,826

(22) Filed: Apr. 23, 2025

(51) Int. Cl. H02S 30/10; H02S 40/10

(52) U.S. Cl. CPC H02S 30/10; H02S 40/10

(57) ABSTRACT

Embodiments described herein relate to an apparatus that includes a solar panel, and a frame around the solar panel. In an embodiment, the frame includes a first edge, a second edge, a corner key configured to couple the first edge to the second edge, and a corner drain coupled to the corner key. In an embodiment, the corner drain includes an inlet configured to drain a fluid from a surface of the solar panel into an interior of the corner drain, and an outlet configured to drain the fluid from the interior of the corner drain.

### BACKGROUND

### 1) Field

Embodiments relate to the field of renewable energy, and in particular, to solar panel frames with corner drains for removing liquid from the surface of the solar panels.

### 2) DESCRIPTION OF RELATED ART

Semiconductor Photovoltaic cells, commonly known as solar cells, are well known devices for direct conversion of solar radiation into electrical energy. Generally, solar cells are fabricated on a semiconductor wafer or substrate using semiconductor processing techniques to form a p-n junction near a surface of the substrate. Solar radiation impinging on the surface of, and entering into, the substrate creates electron and hole pairs in the bulk of the substrate. The electron and hole pairs migrate to p-doped and n-doped regions in the substrate, thereby generating a voltage differential between the doped regions. The doped regions are connected to conductive regions on the solar cell to direct an electrical current from the cell to an external circuit coupled thereto.

Electrical conversion efficiency is an important characteristic of a solar cell as it is directly related to the capability of the solar cell to generate power; with higher efficiency providing additional value to the end customer; and, with all other things equal, higher efficiency also reduces manufacturing cost per Watt.

The efficiency of solar cells is also impacted by the cleanliness of the solar cells during operation. For example, a solar panel that comprises a plurality of solar cells may be exposed to environmental conditions, such as rain, dust, or the like. Over time, dust can form on the surface of the solar cell. The dust reduces the amount of sunlight that reaches the solar cell, and the effective efficiency of the solar panel is reduced. In some instances, water is retained over portions of the solar panel by a frame that surrounds the solar panel. As the water evaporates, the dust within the water remains on the glass. Over time, the dust may accumulate to form a dust band over portions of the solar panel.

### BRIEF DESCRIPTION OF THE DRAWINGS

FIG. 1A is a perspective view illustration of a solar panel with a dust band on a surface of the solar panel, in accordance with an embodiment.

FIG. 1B is a perspective view illustration of a corner of the solar panel with a corner piece that connects adjacent sides of the frame together, in accordance with an embodiment.

FIG. 1C is a perspective view illustration of the corner of the solar panel with an orientation that shows a lip of the frame that confines fluid on the solar panel, in accordance with an embodiment.

FIG. 2 is an exploded view illustration of a corner of a solar panel that shows a frame, a corner key, and a corner piece, in accordance with an embodiment.

FIG. 3A is a cut-away sectional illustration that depicts a fluidic path through a corner drain, in accordance with an embodiment.

FIG. 3B is a perspective view illustration of the corner drain, in accordance with an embodiment.

FIG. 4A is a cut-away sectional illustration that depicts a fluidic path through a corner drain, in accordance with an additional embodiment.

FIG. 4B is a perspective view illustration of the corner drain that shows an outlet of the fluidic path, in accordance with an embodiment.

FIG. 5A is a perspective view illustration of a corner drain that shows snap features on a bottom layer of the corner drain, in accordance with an embodiment.

FIG. 5B is a perspective view illustration of a corner drain that shows snap features on an intermediate layer of the corner drain, in accordance with an embodiment.

FIG. 5C is a perspective view illustration of the corner drain clipped to a corner key, in accordance with an embodiment.

FIG. 5D is a perspective view illustration of the corner drain clipped to the corner key with a view that shows the snap feature engaged to the corner key, in accordance with an embodiment.

FIG. 6A is a perspective view illustration of a corner drain with a recess in a top layer of the corner drain, in accordance with an embodiment.

FIG. 6B is a perspective view illustration of a corner drain with a protrusion from a bottom layer of the corner drain, in accordance with an embodiment.

FIG. 6C is a perspective view illustration of a pair of solar panels that are being stacked together with an alignment and stacking feature provided on the corner drains, in accordance with an embodiment.

### DETAILED DESCRIPTION

Solar panel frames with corner drains for removing liquid from the surface of the solar panels are described herein. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

The following detailed description is merely illustrative in nature and is not intended to limit the embodiments or the application and uses of such embodiments. As used herein, the word “exemplary” means “serving as an example, instance, or illustration.” Any implementation described herein as exemplary is not necessarily preferred or advantageous over other implementations. Furthermore, there is no intention to be bound by any expressed or implied theory presented in the preceding technical field, background, brief summary or the following detailed description.

References to “one embodiment” or “an embodiment.” do not necessarily refer to the same embodiment. Particular features, structures, or characteristics can be combined in any suitable manner consistent with this disclosure.

Terminology. The following paragraphs provide definitions and/or context for terms found in this disclosure (including the appended claims):
“Comprising” is open-ended term does not foreclose additional structure or steps.
“Configured to” connotes structure by indicating that a device, such as a unit or a component, includes structure that performs a task or tasks during operation, such structure is configured to perform the task even when the device is not currently operational (e.g., is not on/active). A device “configured to” perform one or more tasks is expressly intended to not invoke a means or step plus function interpretations under 35 U.S.C. § 112, (f) or sixth paragraph.
“First,” “second,” etc. terms are used as labels for nouns that they precede, and do not imply any type of ordering (e.g., spatial, temporal, logical, etc.). For example, reference to a “first” solar cell does not necessarily mean such solar cell in a sequence; instead the term “first” is used to differentiate this solar cell from another solar cell (e.g., a “second” solar cell).
“Coupled” refers to elements, features, structures or nodes unless expressly stated otherwise, that are or can be directly or indirectly joined or in communication with another element/node/feature, and not necessarily directly mechanically joined together.
“Inhibit” describes reducing, lessening, minimizing or effectively or actually eliminating something, such as completely preventing a result, outcome or future state completely.
“About” or “approximately”. As used herein, the terms “about” or “approximately” in reference to a recited numeric value, including for example, whole numbers, fractions, and/or percentages, generally indicates that the recited numeric value encompasses a range of numerical values (e.g., +/−5 % to +/−10% of the recited value) that one of ordinary skill in the art would consider equivalent to the recited value (e.g., performing substantially the same function, acting in substantially the same way, and/or having substantially the same result).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

As noted above, solar panels that are exposed to environmental elements become dirty over time. For example, dust and/or the like may deposit over the surface of the solar panel. These layers of dust and/or the like block the electromagnetic radiation of the sun from reaching the solar cells of the solar panels. Accordingly, the effective efficiency of the solar panel is reduced. Standing water is a particularly problematic source of dust on the solar panel. As the water evaporates, the dust in the water remains behind.

Many solar panels are oriented at an angle with a rack, stand, or the like, or the solar panels are oriented at an angle by being mounted to a sloped surface (e.g., a sloped roof). Angled mounting configurations may result in water pooling at a bottom of the solar panel. As the water evaporates a band of dust may form across the lower portion of the solar panel.

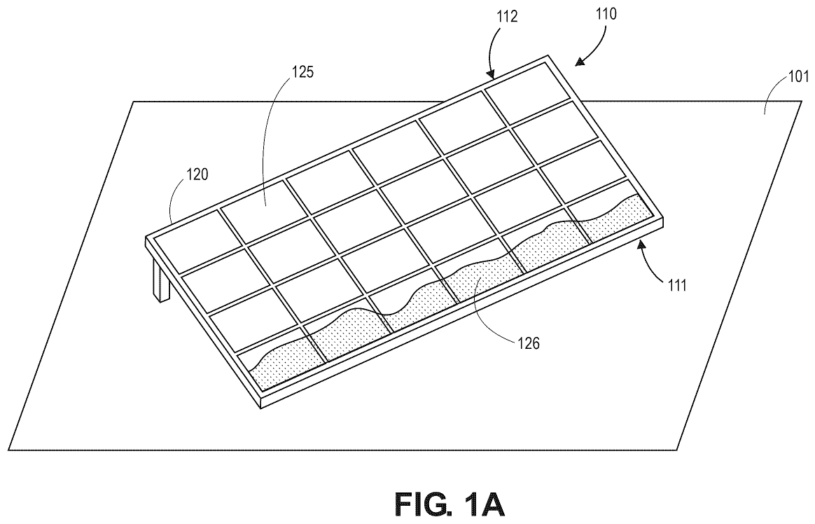

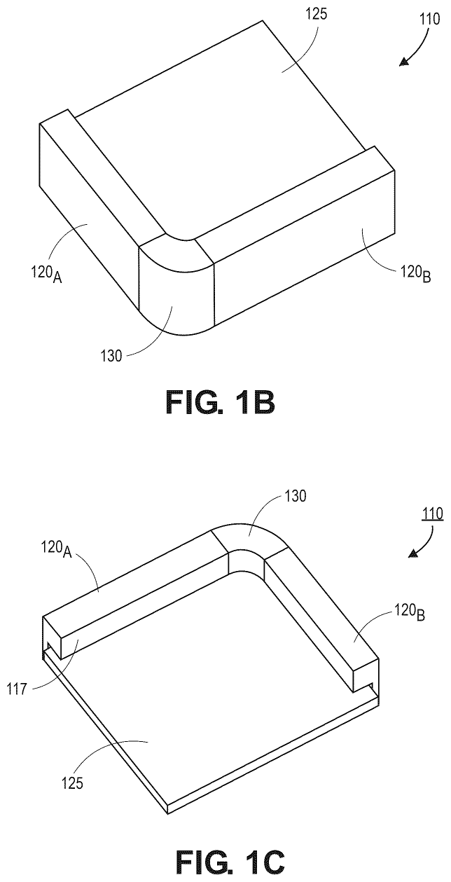

An example of such a solar panel is shown in FIG. 1A. As shown, the solar panel 110 is provided on a surface 101. The solar panel 110 may be angled up so that there is a top edge 112 and a bottom edge 111. The solar panel 110 may include a plurality of solar cells 125 that are arranged in a panel form factor. The panel may be surrounded by a frame 120. The frame 120 may be used in order to protect the edges of the solar panel 110 from damage or the like. When the frame 120 has a lip 117 that extends above the top surface of the solar panel 110, the water is blocked from flowing off of the surface of the solar panel 110. Accordingly, a dust band 126 may be formed adjacent to the bottom edge 111 of the solar panel 110 as a result of the evaporation of pooled water.

Existing frames 120 have a lip 117 that extends above the top surface of the solar panel 110. Examples of such architectures are shown in FIGS. 1B and 1C. FIGS. 1B and 1C are partial views of the solar panel 110 that highlights the construction of the frame 120 at the corner of the solar panel 110. As shown, the frame 120 may comprise individual edges 120A and 120B that are coupled together at a corner. A corner piece 230 may be provided at the corner to protect the corner of the solar cell 125 of the solar panel 110. As will be described in greater detail herein, the edges 120A and 120B may be coupled together by a corner key (not visible in FIGS. 1B and 1C), and the corner piece may be coupled around the corner key. As shown, the edges 120A and 120B of the frame 120 may have a lip 117 that is provided over the top surface of the solar cell 125.

In an embodiment a lip 117 of the edges 120A, 120B, and the corner piece 130 is pressed against the top surface of the solar cell 125. This provides a seal against the surface of the solar cell 125 so that water cannot drain off of the top surface of the solar cell 125 without passing over the top surface of the edges 120A, 120B, and the corer piece 130. Accordingly, some amount of water pools on the solar cell 125 until it is able to evaporate. As noted above, this leads to the formation of the dust band 126 that reduces the efficiency of the solar panel.

Accordingly, embodiments disclosed herein include solar panel frames that comprise a corner drain. Corner drains may be provided at one or more of the corners of the solar panel frame. In contrast to existing frame designs, the corner drain allows for fluid to drain from the surface of the solar panel. As such, the amount of stagnant water on the solar panel is reduced, or stagnant water on the solar panel is substantially eliminated. Without the presence of stagnant water, the generation of dust bands is reduced, and the efficiency of solar panel is increased.

In an embodiment, the corner drains may be detachably coupled to a corner key that retains edges of the frame together. For example, the corner drains may be clipped to the corner key. The corner drain may be detached periodically to clean the corner drain to prevent blockages from forming or to remove blockages when detected. The corner drain may be removed from the frame without disassembling the frame. Accordingly, maintenance of the solar panel is simplified.

Embodiments disclosed herein provide several different architectures for providing a fluidic path from the top of the solar panel within the frame to outside of the frame. In one embodiment, the fluidic path flows into the corner drain and out a back edge of the corner drain. In another embodiment, the fluidic path flows into the corner drain and out a bottom of the corner drain.

Embodiments disclosed herein may also include corner drains that improve storage and/or shipping of solar panels. For example, the corner drains may include stacking features that align and retain solar panels to each other when stacked. In an embodiment, the stacking feature may be a recess on a top surface of the corner drain with a corresponding protrusion on a bottom surface of the corner drain. When stacked, the protrusions may fit into the recess in order to align the stacked solar panels and keep the solar panels from moving laterally with respect to each other.

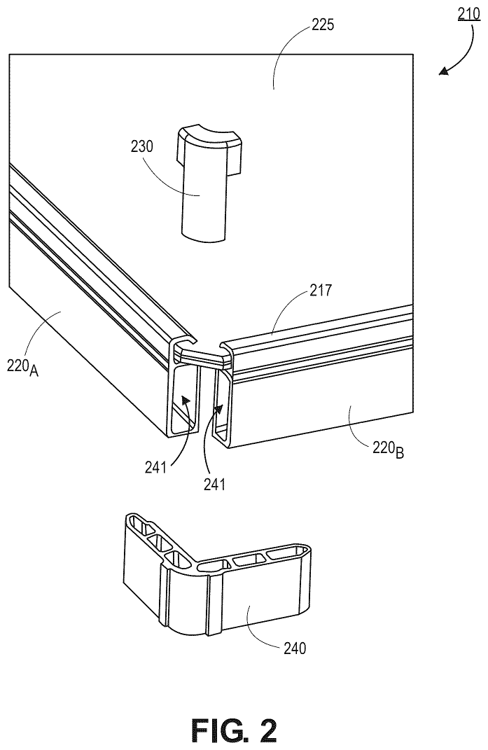

Referring now to FIG. 2, a perspective exploded view illustration of a corner of a solar panel 210 is shown, in accordance with an embodiment. As shown, the solar panel includes a solar cell 225 that is surrounded by a frame 220. The frame 220 may comprise a plurality of edges. In FIG. 2, the edges 220A and 220B are shown. The lip 217 of the edges 220A and 220B can be seen wrapping over a portion of the solar cell 225. In an embodiment, the edges 220A and 220B of the frame have slots 241 to receive a corner key 240. The corner key 240 may be a right-angle piece that fits into both of the slots 241 of the edges 220A and 220. In an embodiment, the corner key 240 may have locking features (not visible in FIG. 2) that secure the corner key 240 within the edges 220A and 220B.

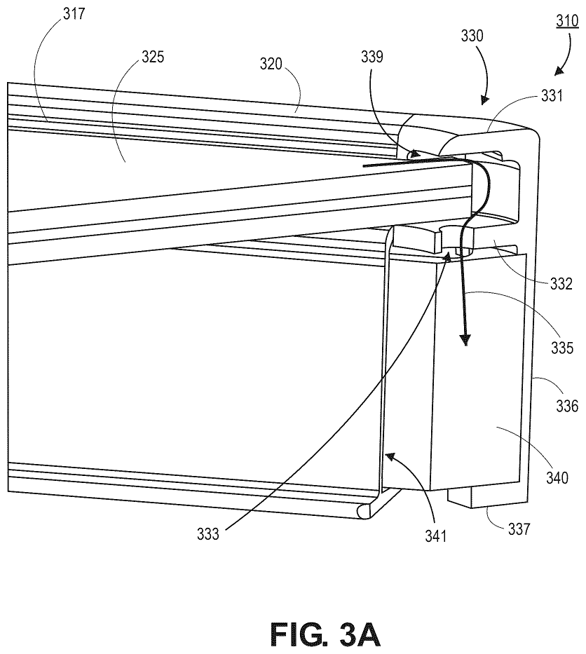

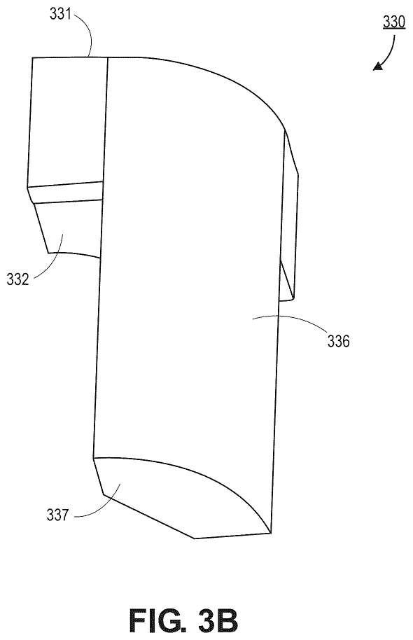

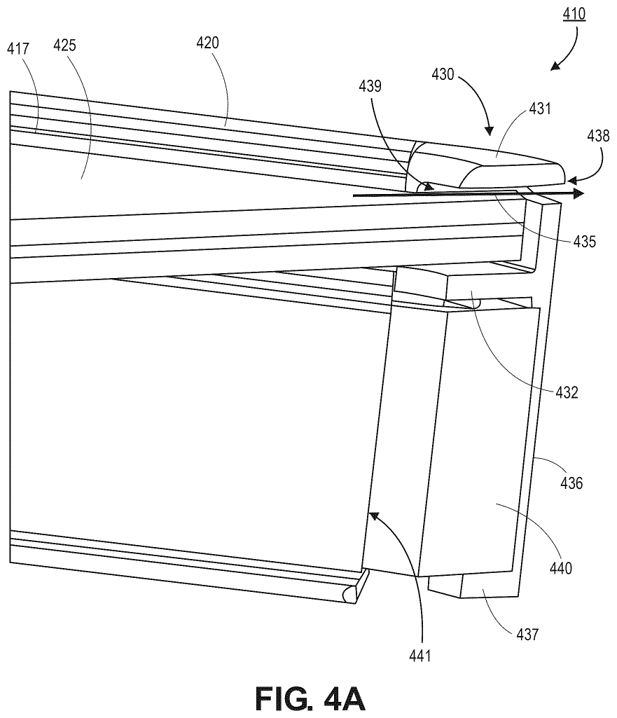

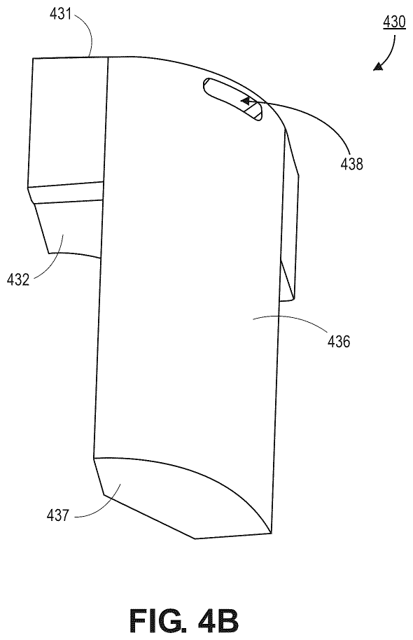

In an embodiment, a corner piece 230 may snap onto the corner key 240. The corner piece 230 may sit flush with the top surface of the edges 220A and 220B in order to form a substantially continuous frame around the perimeter of the solar panel 210. In the illustrated embodiment, the corner piece 230 may not have any fluidic paths to drain water from over the surface of the solar cell 225. Though, it is to be appreciated that the corner piece 230 may have an integrated fluidic path that allows for water to drain from the surface of the solar cell 225. Embodiments with different fluidic path configurations are shown in greater detail with respect to FIGS. 3A-4B .

Referring now to FIG. 3A, a cutaway perspective view illustration of a corner of a solar panel 310 is shown, in accordance with an embodiment. In an embodiment, the solar panel 310 may comprise a solar cell 325 that is secured by a frame 320. The solar cell 325 may be a single solar cell. Though, it is to be appreciated that references to a “solar cell” with respect to embodiments disclosed herein may refer to a larger panel that comprises a plurality of solar cells, layers around the solar cells (e.g., glass, metal, etc.), and/or any other structures that may be considered part of a solar panel that is surrounded by the frame 320. The plane of the cut in FIG. 3A removes the adjacent edge of the frame, but it is to be appreciated that the solar cell 325 may be secured along all edges by portions of the frame 320. The solar cell 325 may extend below a lip 317 of the frame 320, and the lip 317 of the frame may contact a top surface of the solar cell 325. In an embodiment, a corner of the solar cell 325 may be surrounded by a corner drain 330. The corner drain 330 may be similar in construction to any of the corner pieces described in greater detail herein, with the exception of the inclusion of a fluidic pathway in order to allow fluid (e.g., water) to drain away from the top surface of the solar cell 325.

In an embodiment, the corner drain 330 may comprise a first layer 331 that is coupled to a second layer 337 by a wall 336. In some instances, the wall 336 may be referred to as an exterior wall since the wall 336 forms an outer surface of the corner drain 330 when the corner drain 330 is coupled to the solar panel 310. An intermediate layer 332 may be coupled to the wall 336 and be provided between the first layer 331 and the second layer 337. In some embodiments, the first layer 331 may be referred to as a top layer, and the second layer 337 may be referred to as a bottom layer. In an embodiment, the intermediate layer 332 may be closer to the first layer 331 than the second layer 337. In an embodiment, the solar cell 325 may be surrounded by a portion of the corner drain 330. For example, portions of the first layer 331, the wall 336, and the intermediate layer 332 may wrap around a corner portion of the solar cell 325. In some instances, the solar cell 325 is supported on the intermediate layer 332. Though, in other embodiments, the solar cell 325 may be spaced away from the intermediate layer 332.

In an embodiment, the corner drain 330 may be coupled to a corner key 340 that is inserted into a slot 341 of the frame 320. As will be described in greater detail herein, the corner drain 330 may be clipped to the corner key 340 so that the corner drain 330 may be removed for cleaning at desired intervals and/or when a clog forms along the fluidic path of the corner drain 330. The corner drain 330 may have coupling features such as bosses, clips, or the like (not visible in FIG. 3A) that are provided on the bottom surface of the intermediate layer 332 and/or the top surface of the second layer 337. The coupling features may engage the corner key 340.

As shown, the corner drain 330 provides a fluidic path 335 that allows for fluid on the top surface of the solar cell 325 to drain out of the solar panel 310. In an embodiment, the fluidic path 335 comprises an inlet 339 and an outlet 333. The inlet 339 may be a gap or opening that is provided between the first layer 331 and the top surface of the solar cell 325. As shown, the first layer 331 may contact the solar cell 325 at some locations and be spaced apart from the solar cell 325 at other locations (e.g., the inlet 339). Once the fluid enters an interior of the corner drain 330 through the inlet 339, the fluidic path 335 continues around the edge of the solar cell 325 towards the intermediate layer 332. In some embodiments, an outlet 333 is provided through a thickness of the intermediate layer 332. For example, a hole is shown as the outlet 333 in FIG. 3A. Though, in other embodiments, the outlet 333 may be a gap between the bottom surface of the solar cell 325 and a top surface of the intermediate layer 332. The fluid may continue along the fluidic path 335 through the corner key 340 and out of the solar panel 310.

Referring now to FIG. 3B, a perspective view illustration of the backside of the corner drain 330 is shown, in accordance with an embodiment. As shown, the wall 336 extends down from the first layer 331 and the intermediate layer 332. A portion of the wall 336 may be provided between the first layer 331 and the intermediate layer 332. A narrower portion of the wall 336 may continue down to the second layer 337. In an embodiment, the second layer 337 and the lower portion of the wall 336 have substantially the same width. In an embodiment, the wall 336 has a rounded surface to provide a smooth corner for the solar panel 310. Though, in other embodiments, the wall 336 may comprise a sharper corner profile. In the embodiment illustrated in FIG. 3B, the wall 336 is substantially solid. That is, there may not be any inlets and/or outlets that pass through a thickness of the wall 336.

In an embodiment, the corner drain 330 may comprise any suitable material or materials. For example, the corner drain 330 may be a plastic material, a metallic material, or the like. In an embodiment, the corner drain 330 may be a monolithic structure, such as an injection molded part or the like. Though, embodiments may also include a corner drain 330 that comprises a plurality of components that are coupled together (e.g., welded, secured by an adhesive, bolts, screws, snaps, etc.).

Referring now to FIG. 4A, a cutaway perspective view illustration of a corner of a solar panel 410 is shown, in accordance with an additional embodiment. In an embodiment, the solar panel 410 may comprise a solar cell 425 that is secured by a frame 420. The plane of the cut in FIG. 4A removes the adjacent edge of the frame, but it is to be appreciated that the solar cell 425 may be secured along all edges by portions of the frame 420. The solar cell 425 may extend below a lip 417 of the frame 420, and the lip 417 of the frame may contact a top surface of the solar cell 425. In an embodiment, a corner of the solar cell 425 may be surrounded by a corner drain 430. The corner drain 430 may be similar in construction to any of the corner pieces described in greater detail herein, with the exception of the inclusion of a fluidic pathway in order to allow fluid (e.g., water) to drain away from the top surface of the solar cell 425.

In an embodiment, the corner drain 430 may comprise a first layer 431 that is coupled to a second layer 437 by a wall 436. In some instances, the wall 436 may be referred to as an exterior wall since the wall 336 forms an outer surface of the corner drain 330 when the corner drain 330 is coupled to the solar panel 310. An intermediate layer 432 may be coupled to the wall 436 and be provided between the first layer 431 and the second layer 437. In some embodiments, the first layer 431 may be referred to as a top layer and the second layer 437 may be referred to as a bottom layer. In an embodiment, the intermediate layer 432 may be closer to the first layer 431 than the second layer 437. In an embodiment, the solar cell 425 may be surrounded by a portion of the corner drain 430. For example, portions of the first layer 431, the wall 436, and the intermediate layer 432 may wrap around a corner portion of the solar cell 425. In some instances, the solar cell 425 is spaced away from the intermediate layer 432. Though, in other embodiments, the solar cell 425 may be supported by the intermediate layer 432.

In an embodiment, the corner drain 430 may be coupled to a corner key 440 that is inserted into a slot 441 of the frame 420. As will be described in greater detail herein, the corner drain 430 may be clipped to the corner key 440 so that the corner drain 430 may be removed for cleaning at desired intervals and/or when a clog forms along the fluidic path of the corner drain 430. The corner drain 430 may have coupling features such as bosses, clips, or the like (not visible in FIG. 4A) that are provided on the bottom surface of the intermediate layer 432 and/or the top surface of the second layer 437. The coupling features may engage the corner key 440.

As shown, the corner drain 430 provides a fluidic path 435 that allows for fluid on the top surface of the solar cell 425 to drain out of the solar panel 410. In an embodiment, the fluidic path 435 comprises an inlet 439 and an outlet 438. The inlet 439 may be a gap or opening that is provided between the first layer 431 and the top surface of the solar cell 425. As shown, the first layer 431 may contact the solar cell 425 at some locations and be spaced apart from the solar cell 425 at other locations (e.g., the inlet 439). Once the fluid enters an interior of the corner drain 430 through the inlet 439, the fluidic path 435 continues towards the edge of the solar cell 425. As shown, the edge of the solar cell 425 may contact an inner surface of the wall 436, and an outlet 438 may be provided through the wall 436 proximate to where the solar cell 425 and the wall 436 meet. In such an embodiment, water may be prevented from extending down along an edge of the solar cell 425.

Referring now to FIG. 4B, a perspective view illustration of the backside of the corner drain 430 is shown, in accordance with an embodiment. As shown, the corner drain 430 in FIG. 4B may be similar to the corner drain 330 in FIG. 3B, with the exception of the addition of an outlet 438 through the wall 436. The outlet 438 allows for fluid to flow out of the corner drain 430 without needing to be routed down around the edges of the solar cell (not visible in FIG. 4B). The corner drain 430 may comprise any suitable material or materials. For example, the corner drain 430 may be a plastic material, a metallic material, or the like. In an embodiment, the corner drain 430 may be a monolithic structure, such as an injection molded part or the like. Though, embodiments may also include a corner drain 430 that comprises a plurality of components that are coupled together (e.g., welded, secured by an adhesive, bolts, screws, snaps, etc.).

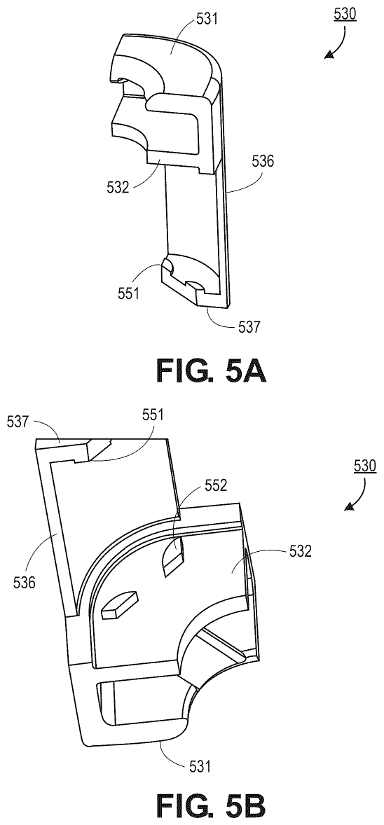

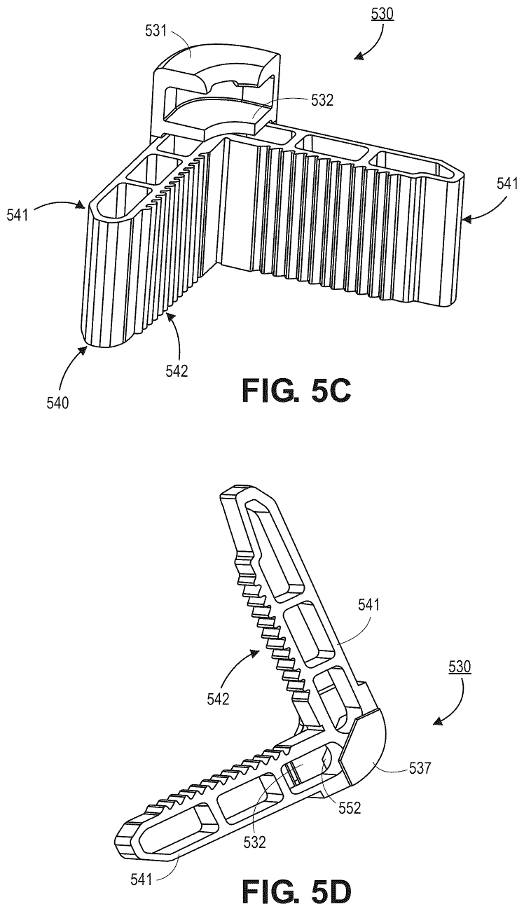

Referring now to FIGS. 5A and 5B, perspective view illustrations of portions of a corner drain 530 are shown, in accordance with an embodiment. In an embodiment, the corner drain 530 may be similar to any of the corner drains described in greater detail herein. For example, the corner drain 530 may comprise a first layer 531, a second layer 537, an intermediate layer 532, and a wall 536 to connect the layers together. The corner drain 530 may define a fluidic path for draining fluid from a solar panel that is similar to any of those described herein. For example, an outlet may be formed through the wall 536 between the first layer 531 and the intermediate layer 532 (e.g., similar to the embodiment shown in FIGS. 4A and 4B), or the outlet may be formed through the intermediate layer 532 (e.g., similar to the embodiment shown in FIGS. 3A and 3B).

FIG. 5A is oriented so that a top surface of the second layer 537 is visible. As shown, one or more bosses 551, protrusions, or the like may be formed on the top surface of the second layer 537. The bosses 551 may be sized and shaped so as to engage a corner key (not shown in FIG. 5A) in order to retain the corner drain 530 to the corner key. Additionally, the snapping and/or clipping action between the bosses 551 and the corner key allow for relatively simple detachment of the corner key (e.g., to allow for cleaning and/or other maintenance) without the need to disassemble the frame of the solar panel.

Similarly, FIG. 5B is oriented so that the bottom surface of the intermediate layer 532 is shown. In an embodiment, one or more bosses 552, protrusions, or the like extend out from the bottom surface of the intermediate layer 532. The bosses 552 may be used to secure the corner drain 530 to the corner key (not shown in FIG. 5B). As such, the bosses 551 and the bosses 552 may be used to couple the corner drain 530 to the top and bottom edges of the corner key.

Referring now to FIG. 5C, a perspective view illustration of the corner drain 530 coupled to a corner key 540 is shown, in accordance with an embodiment. In an embodiment, the corner key 540 may comprise a pair of arms 541 that meet at substantially a right angle. The arms 541 fit into slots of a frame (not shown) in order to secure the edges of the frame together, as described in greater detail herein. In some embodiments, the arms 541 may comprise ridges 542 or other coupling mechanisms that secure the corner key 540 to the frame.

As shown, the corner drain 530 is coupled around the corner of the corner key 540 where the arms 541 meet. The intermediate layer 532 may be provided over a top edge of corner key 540. For example, bosses 552 on the underside of the intermediate layer 532 may clip to portions of the corner key 540. The engagement of the bosses 552 and the corner key 540 is shown in FIG. 5D, which shows a bottom of the corner key 540 and the second layer 537. Similar to the bosses 552 engaging the corner key 540, the bosses (not visible in FIG. 5D) on the second layer 537 may engage an edge of the corner key 540. As such, the corner drain 530 is clipped to the corner key 540 in a secure manner. Further, the corner drain 530 may be easily removed from the corner key 540 in order to clean the corner key 540 (e.g., to remove blockages or the like), or to provide any other suitable maintenance.

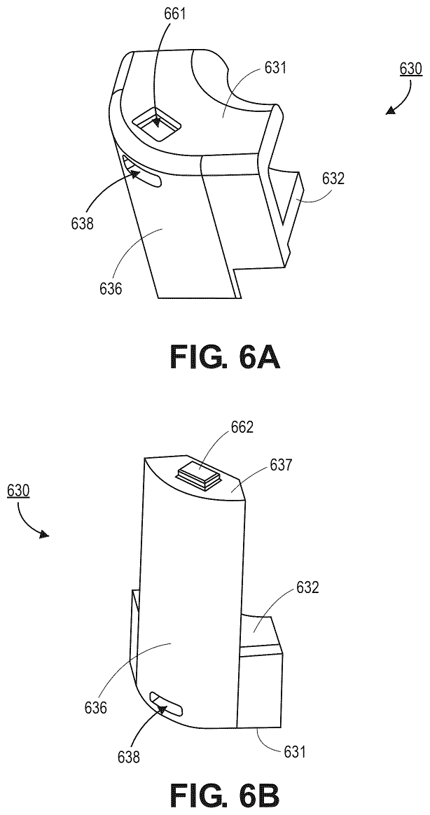

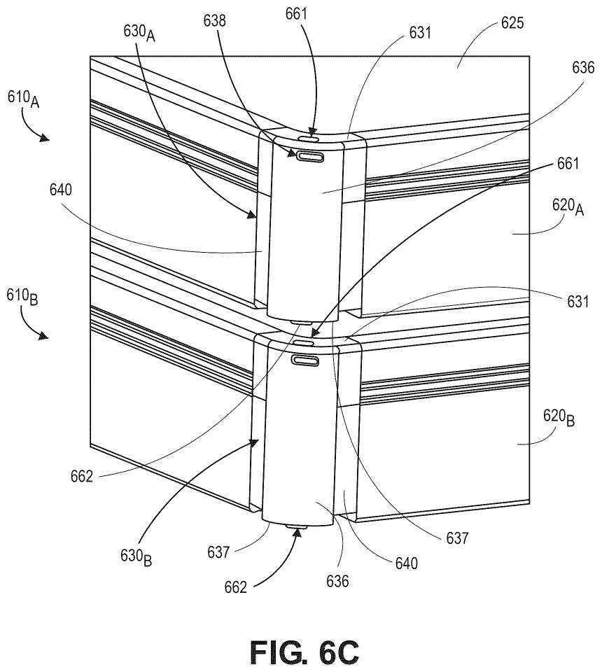

Referring now to FIGS. 6A-6C, a series of illustrations that depict corner drains 630 that are modified to improve solar panel stacking is shown, in accordance with an embodiment. In an embodiment, the corner drains 630 may further include interlocking features on the top and bottom surfaces. When solar panels are stacked the interlocking features help to improve alignment of the stacked solar panels and prevent shifting of the stack of solar panels. This allows for improved storage, transportation, and/or the like.

Referring now to FIG. 6A, a perspective view illustration of a portion of a corner drain 630 is shown, in accordance with an embodiment. In an embodiment, the corner drain 630 may be similar to any of the corner drains described in greater detail herein, with the exception of the inclusion of the interlocking features. For example, the corner drain 630 may comprise a first layer 631, a second layer 632, and a wall 636. A second layer (not shown in FIG. 6A) may be provided at a bottom of the wall 636. In the embodiment shown in FIG. 6A, the outlet 638 for the fluidic path through the corner drain 630 is through the wall 636 between the first layer 631 and the intermediate layer 632. Though, an outlet may be provided through the intermediate layer 632 similar to other embodiments described in greater detail herein.

In an embodiment, a recess 661 may be formed into a top surface of the first layer 631. The recess 661 may have any suitable shape, size, depth, and/or the like. For example, in FIG. 6A the recess 661 is substantially rectangular. The recess 661 may be sized and shaped in order to receive a protrusion 662 that is formed on a bottom surface of the second layer 637, as shown in FIG. 6B. Accordingly, when solar panels are stacked on each other, the protrusion 662 of an overlying solar panel may sit in the recess 661 of the underlying solar panel. The interlocking nature of the recess 661 and the protrusion 662 allows for improved alignment of the solar panels as well as reducing shifting of solar panels in a stack during storage and/or transport. While the protrusion 662 is shown as being on the bottom of the corner drain 630 and the recess 661 is shown as being on the top of the corner drain 630, embodiments may also include the recess 661 being on the bottom of the corner drain 630 and the protrusion 662 being on the top of the corner drain 630.

Referring now to FIG. 6C, a perspective view illustration of a stack of solar panels 610 is shown, in accordance with an embodiment. As shown, the solar panel 610A is stacked over a solar panel 610B. The solar panels 610 may be similar to any of the solar panels described in greater detail herein. For example, the solar panels 610 may comprise frames (e.g., frame 620A for solar panel 610A and frame 620B for solar panel 610B) that surround solar cells 625. The frames 620 may be coupled together by corner keys 640, and corner drains 630 (e.g., corner drain 630A and corner drain 630B) may be coupled to the corner keys 640. In an embodiment, the corner drains 630 may include outlets 638 to allow fluid on the solar cells 625 to drain out of the solar panel 610.

As shown in FIG. 6C, the corner drains 630 may also comprise recesses 661 on the top surface of the first layer 631 and a protrusion 662 on the bottom surface of the second layer 637. As such, the protrusions 662 may insert into the recesses 661 in order to improve the stacking of solar panels 610. In an embodiment, any number of solar panels 610 may be stacked with such an interlocking system. In some embodiments all four corners of the solar panels 610 may comprise the interlocking stacking features.

In the foregoing specification, specific exemplary embodiments have been described. It will be evident that various modifications may be made thereto without departing from the scope of the following claims. The specification and drawings are, accordingly, to be regarded in an illustrative sense rather than a restrictive sense.

1. An apparatus, comprising:
a solar panel; and
a frame around the solar panel, wherein the frame comprises:
a first edge;
a second edge;
a corner key configured to couple the first edge to the second edge; and
a corner drain coupled to the corner key, wherein the corner drain comprises:
an inlet configured to drain a fluid from a surface of the solar panel into an interior of the corner drain; and
an outlet configured to drain the fluid from the interior of the corner drain;
wherein the corner drain comprises:
a top surface and a bottom surface; and
an intermediate layer between the top surface and the bottom surface;
wherein the outlet is provided through a thickness of the intermediate layer.

2. The apparatus of claim 1, wherein the outlet passes through an exterior wall of the corner drain.

3. The apparatus of claim 1, wherein the outlet is below the solar panel.

4. The apparatus of claim 1, wherein the corner drain is clipped onto the corner key.

5. (canceled)

6. The apparatus of claim 1, further comprising a recess into the top surface and a protrusion from the bottom surface.

7. The apparatus of claim 1, wherein the inlet is between the top surface of the corner drain and the surface of the solar panel.

8. The apparatus of claim 1, wherein the solar panel is positioned between the top surface and the intermediate layer.

9. An apparatus, comprising:
a first layer;
a second layer under the first layer, wherein the first layer is coupled to the second layer by a wall;
an intermediate layer between the first layer and the second layer; and
a hole through a surface of the apparatus, wherein the hole is between the first layer and the second layer;
wherein the hole is through the intermediate layer.

10. The apparatus of claim 9, further comprising:
a protrusion on a surface of the second layer that faces away from the first layer; and
a recess into a surface of the first layer that faces away from the second layer, wherein the protrusion is sized and shaped to nest into the recess.

11. The apparatus of claim 9, further comprising:
a first boss on a surface of the second layer that faces the intermediate layer; and
a second boss on a surface of the intermediate layer that faces the second layer.

12. The apparatus of claim 11, wherein the first boss and the second boss are configured to clip the apparatus to a corner of a frame.

13. The apparatus of claim 12, wherein the frame surrounds a solar panel, and wherein the solar panel fits between the first layer and the intermediate layer.

14. (canceled)

15. The apparatus of claim 9, further comprising another hole extending through the wall between the first layer and the intermediate layer.

16. The apparatus of claim 9, wherein the second layer and the wall have equal widths.

17. The apparatus of claim 9, wherein the intermediate layer is closer to the first layer than the second layer.

18. An apparatus, comprising:
a solar panel; and
a frame around the solar panel, wherein the frame comprises a corner drain at a corner of the frame that provides a fluidic path that is configured to allow a fluid on the solar panel to drain off of the solar panel, and wherein the fluidic path passes between a top surface of the corner drain and a surface of the solar panel;
wherein the corner drain comprises an outlet for the fluidic path, wherein the outlet passes through an intermediate layer of the corner drain that is below the solar panel.

19. The apparatus of claim 18, wherein the corner drain comprises another outlet for the fluidic path, wherein the another outlet passes through an exterior wall of the corner drain.

20. (canceled)
